(19) United States
(12) Patent Application Publication
(10) Pub. No.: US 2026/0093865 A1
(43) Pub. Date: Apr. 2, 2026

(54) INFORMATION PROCESSING METHOD, COMPUTER PROGRAM, AND INFORMATION PROCESSING APPARATUS

(71) Applicant: Tokyo Electron Limited, Tokyo (JP)

(72) Inventor: Ryoji ANZAKI, Tokyo (JP)

(73) Assignee: Tokyo Electron Limited, Tokyo (JP)

(21) Appl. No.: 19/333,364

(22) Filed: Sep. 19, 2025

(30) Foreign Application Priority Data
Sep. 27, 2024 (JP) 2024-169235

(51) Int. Cl. G06F 30/20; G06F 111/04; H01J 37/32

(52) U.S. Cl. CPC G06F 30/20; H01J 37/32926; H01J 37/3299; G06F 2111/04

(57) ABSTRACT

An information processing method includes, by an information processing apparatus, acquiring an upper-level target trajectory as an output target of the upper-level model, generating a lower-level target trajectory as an output target of the lower-level model based on the upper-level target trajectory, providing the lower-level target trajectory to the lower-level model to acquire a lower-level estimated trajectory output by the lower-level model, performing a simulation based on the lower-level estimated trajectory to calculate an upper-level estimated trajectory related to an output value of the upper-level model, when the upper-level estimated trajectory does not satisfy a given condition, updating the lower-level target trajectory of the lower-level model to recalculate the upper-level estimated trajectory, and when the upper-level estimated trajectory satisfies the given condition, outputting the lower-level target trajectory as a target trajectory of the lower-level model.

### CROSS-REFERENCE TO RELATED APPLICATION

This application claims the benefit of priority from Japanese Patent Application No. 2024-169235, filed on Sep. 27, 2024, the entire contents of which are incorporated herein by reference.

### TECHNICAL FIELD

The present disclosure relates to an information processing method, a computer program, and an information processing apparatus.

### BACKGROUND

PTL 1 proposes an information processing system that executes a simulation of a process state being executed by a semiconductor manufacturing apparatus using a simulation model of the semiconductor manufacturing apparatus. The information processing system acquires physical sensor data measured by the semiconductor manufacturing apparatus that executes a process according to a process parameter, executes a simulation by a simulation model according to the process parameter and calculates virtual sensor data and virtual process result data, and visualizes the process state of the semiconductor manufacturing apparatus and displays the process state on a display during the execution of the process using the physical sensor data, the virtual sensor data, and the virtual process result data.

### CITATION LIST

### Patent Documents

PTL 1: JP2021-132140A

### SUMMARY

The present disclosure provides an information processing method, a computer program, and an information processing apparatus that can be expected to achieve control of substrate processing using a substrate processing model that models a behavior of a substrate processing apparatus.

An information processing method according to an embodiment is an information processing method in which an information processing apparatus uses a substrate processing model related to substrate processing performed by a substrate processing apparatus to generate a target trajectory for the substrate processing of the substrate processing apparatus. The substrate processing model includes an upper-level model and a lower-level model connected to the upper-level model. The upper-level model and the lower-level model are models that receive the target trajectory as an output target and output an estimated trajectory estimated for the target trajectory. The information processing method includes: by the information processing apparatus, acquiring an upper-level target trajectory as the output target of the upper-level model, generating a lower-level target trajectory as the output target of the lower-level model based on the acquired upper-level target trajectory, providing the generated lower-level target trajectory to the lower-level model to acquire a lower-level estimated trajectory output by the lower-level model, performing a simulation based on the acquired lower-level estimated trajectory to calculate an upper-level estimated trajectory related to an output value of the upper-level model, when the calculated upper-level estimated trajectory does not satisfy a given condition, updating the lower-level target trajectory of the lower-level model to recalculate the upper-level estimated trajectory, and when the calculated upper-level estimated trajectory satisfies the given condition, outputting the lower-level target trajectory as a target trajectory of the lower-level model.

According to the present disclosure, the control of the substrate processing using the substrate processing model that models the behavior of the substrate processing apparatus can be expected to be achieved.

### BRIEF DESCRIPTION OF DRAWINGS

FIG. 1 is a schematic diagram illustrating an overview of an information processing system according to the present embodiment.

FIG. 2 is a schematic diagram illustrating an overview of control of a substrate processing apparatus using a substrate processing model.

FIG. 3 is a schematic diagram illustrating a configuration example of the substrate processing model.

FIG. 4 is a block diagram illustrating a configuration example of an information processing apparatus according to the present embodiment.

FIG. 5 is a flowchart illustrating an example of a procedure of optimization processing with respect to an overall function Ω performed by the information processing apparatus in the present embodiment.

FIG. 6 is a flowchart illustrating an example of a procedure of optimization processing with respect to a functional unit X performed in the optimization processing with respect to the overall function Ω.

FIG. 7 is a flowchart illustrating an example of a procedure of optimization processing with respect to a control system Z performed in the optimization processing with respect to the functional unit X.

FIG. 8 is a schematic diagram illustrating a correspondence relationship between each layer of the substrate processing model and a target period of the optimization processing.

### DETAILED DESCRIPTION

Hereinafter, a specific example of an information processing system according to the embodiment of the present disclosure will be described with reference to the drawings. The present disclosure is not limited to these examples, and is defined by the claims, and is intended to include all modifications within the meaning and scope equivalent to the claims.

### <System Overview>

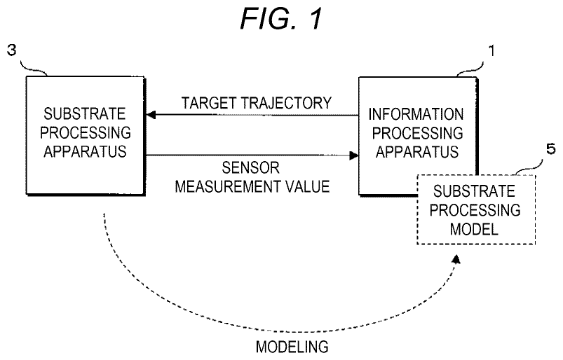

FIG. 1 is a schematic diagram illustrating an overview of an information processing system according to the present embodiment. The information processing system according to the present embodiment includes an information processing apparatus 1 and a substrate processing apparatus 3. The substrate processing apparatus 3 is an apparatus that performs various types of substrate processing such as Chemical Vapor Deposition (CVD), sputtering, or etching on a substrate (wafer) of a semiconductor, for example. The information processing apparatus 1 is an apparatus that monitors and controls an operation of the substrate processing apparatus 3. The information processing apparatus 1 causes the substrate processing apparatus 3 to perform desired substrate processing based on, for example, setting information about substrate processing (so-called recipe) generated in advance by a user. The information processing apparatus 1 and the substrate processing apparatus 3 may be integrated apparatuses or may be separate apparatuses. In a case of being separate apparatuses, the information processing apparatus 1 and the substrate processing apparatus 3 can exchange information through, for example, wired or wireless communication.

In the present embodiment, the information processing apparatus 1 generates target trajectories for various hardware units such as controllers provided in the substrate processing apparatus 3 based on the provided recipes, and provides the plurality of target trajectories generated for each of the plurality of controllers and the like to the substrate processing apparatus 3. In the present embodiment, the target trajectory is information obtained by collecting target values of output values of the controller or the like at a plurality of time points, and may be treated as, for example, data in which the target values of the controller or the like are arranged in time series. The substrate processing apparatus 3 provides the target trajectory provided from the information processing apparatus 1 to the corresponding controller or the like, and each controller or the like operates to achieve a trajectory with the same output value as the provided target trajectory.

The substrate processing apparatus 3 includes various sensors, and provides results obtained by measuring various values related to substrate processing by sensors to the information processing apparatus 1 as sensor measurement values. In the present embodiment, the substrate processing apparatus 3 uses a sensor to measure an output value of a controller or the like for which the target trajectory is provided, and provides a trajectory with an output value obtained by collecting measurement values of output values of the controller or the like at a plurality of time points, to the information processing apparatus 1. The information processing apparatus 1 compares the target trajectory provided to the substrate processing apparatus 3 with the trajectory with the output value provided as the sensor measurement value from the substrate processing apparatus 3, thereby calculating a control error and the like, and using the calculated error and the like for generation of the next target trajectory.

In the information processing system according to the present embodiment, a substrate processing model 5 that reproduces a behavior of the substrate processing apparatus 3 when performing substrate processing is generated in advance, and the generated substrate processing model 5 is stored in advance in the information processing apparatus 1. The information processing apparatus 1 performs optimization processing using the substrate processing model 5 when controlling the substrate processing apparatus 3, thereby generating an optimal target trajectory that achieves a target for the substrate processing set in a recipe or the like. By providing the substrate processing apparatus 3 with the optimal target trajectory generated by the information processing apparatus 1 using the substrate processing model 5, it is expected that the substrate processing apparatus 3 is to perform optimal substrate processing to achieve the target set in the recipe or the like. The integration of the substrate processing model 5 with the physical substrate processing apparatus 3 provides a practical application for the simulation and optimization processes. Specifically, the generated optimal target trajectories are transmitted to hardware units (e.g., controllers for frequency, capacitors, valves) in the substrate processing apparatus 3 to cause physical operations on a substrate, such as depositing or etching material layers. Sensor measurements (e.g., output values from controllers) received during processing are compared to the trajectories to calculate errors, and the models are updated in real time to refine future trajectories, thereby improving process accuracy and reducing defects in semiconductor fabrication.

The substrate processing model 5 may be referred to as a so-called digital twin of the substrate processing apparatus 3, and various models such as a physical model represented by a given arithmetic expression or a machine learning model such as a neural network may be adopted, for example. In the present embodiment, the substrate processing model 5 is generated in advance by the information processing apparatus 1, another server apparatus, or the like, based on data obtained through substrate processing performed by the substrate processing apparatus 3 (data such as setting value data and a sensor measurement value input to the substrate processing apparatus 3). Since a method of generating these models is an existing technique, a detailed description thereof will be omitted in the present embodiment.

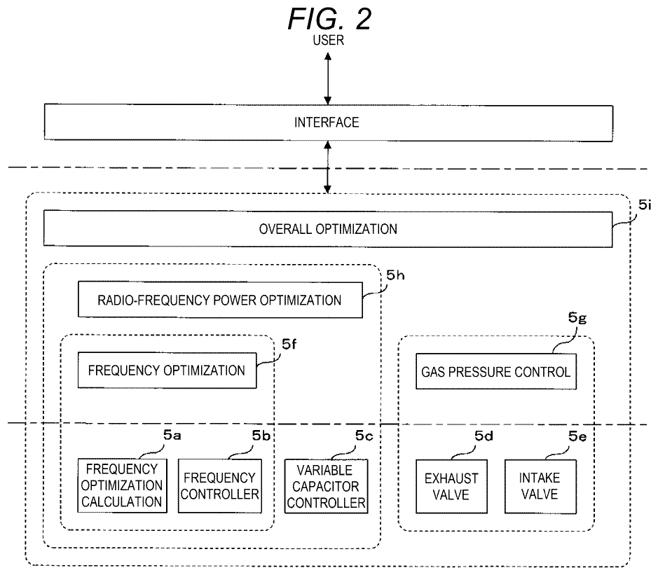

FIG. 2 is a schematic diagram illustrating an overview of control of the substrate processing apparatus 3 using the substrate processing model 5. In the illustrated example, it is assumed that the substrate processing apparatus 3 includes, for example, hardware units such as a device that performs “frequency optimization calculation”, a “frequency controller”, a “variable capacitor controller”, an “exhaust valve”, and an “intake valve”. The substrate processing model 5 in the present example includes a frequency optimization calculation model 5a, a frequency controller model 5b, a variable capacitor controller model 5c, an exhaust valve model 5d, an intake valve model 5e, and the like corresponding to these hardware units provided in the substrate processing apparatus 3. The substrate processing model 5 further includes a frequency optimization model 5f for performing frequency optimization using the frequency optimization calculation model 5a and the frequency controller model 5b, a gas pressure control model 5g for performing gas pressure control using the exhaust valve model 5d and the intake valve model 5e, a radio-frequency power optimization model 5h for performing radio-frequency power optimization using the frequency optimization model 5f and the variable capacitor controller model 5c, and an overall optimization model 5i for performing overall optimization of the substrate processing using the gas pressure control model 5g and the radio-frequency power optimization model 5h.

The information processing apparatus 1 can exchange information between a user and the substrate processing model 5 through an appropriate interface. The information processing apparatus 1 receives an input of a target value for the substrate processing from the user via, for example, the interface, calculates an optimal target trajectory that can achieve the received target value by optimization processing using the substrate processing model 5, and provides the calculated target trajectory to the substrate processing apparatus 3 to perform the substrate processing. The information processing apparatus 1 provides information such as the sensor measurement value obtained as a result of performing the substrate processing to the user through an appropriate interface.

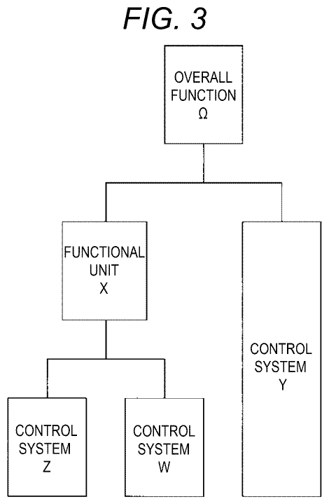

FIG. 3 is a schematic diagram illustrating a configuration example of the substrate processing model 5. A configuration of the substrate processing model 5 illustrated in FIG. 3 is a generalized and simplified configuration of the substrate processing model 5 illustrated in FIG. 2. The substrate processing model 5 is implemented by connecting a plurality of models in a layered manner. In the illustrated example, the substrate processing model 5 includes three models (hereinafter referred to as control systems Y, Z, and W) corresponding to devices of a control system of the substrate processing apparatus 3, a model (hereinafter referred to as a functional unit X) corresponding to functions of upper layers of the control systems Z and W, and a model (hereinafter referred to as an overall function Ω) which is a function of upper layers of the functional unit X and the control system Y and corresponds to an overall function of the substrate processing apparatus 3.

The plurality of models in the substrate processing model 5 are connected to each other in a so-called tree-type layered structure. That is, in the substrate processing model 5, the overall function Ω is provided in the uppermost layer, the functional unit X and the control system Y are connected as a layer below the overall function Ω, and the control system Z and the control system W are connected as a layer below the functional unit X. In the tree structure, the overall function Ω corresponds to a root node, the control systems Y, Z, and W correspond to leaf nodes, and the functional unit X corresponds to internal nodes other than that. For example, a model of the leaf node may be a model that reproduces a behavior of a physical hardware unit of the substrate processing apparatus 3, and a model of the other nodes may be a model that calculates abstract or logical values based on results of a physical behavior by the model of the leaf node. The illustrated tree structure is an example, and the disclosure is not limited thereto. The substrate processing model 5 may have any layered structure.

When the configuration of the substrate processing model 5 illustrated in FIG. 3 is compared with the configuration of the substrate processing model 5 illustrated in FIG. 2, for example, the overall function Ω can be regarded as corresponding to the radio-frequency power optimization model 5h. In this case, the functional unit X may be regarded as corresponding to the frequency optimization model 5f, the control system Y may be regarded as corresponding to the variable capacitor controller model 5c, the control system Z may be regarded as corresponding to the frequency optimization calculation model 5a, and the control system W may be regarded as corresponding to the frequency controller model 5b. For example, the overall function Ω may be regarded as corresponding to the overall optimization model 5i. In this case, the functional unit X corresponds to the radio-frequency power optimization model 5h, the control system Y corresponds to the gas pressure control model 5g, the control system Z corresponds to the frequency optimization model 5f, and the control system W may be regarded as corresponding to the variable capacitor controller model 5c. A correspondence relationship between these models is an example, and is not limited thereto.

In any case, the substrate processing model 5 according to the present embodiment is a model in which a plurality of models such as the overall function Ω, the functional unit X, and the control systems Y, Z, and W are connected to each other in a layered manner. When a target trajectory is input, each model in substrate processing model 5 outputs an estimated trajectory that estimates a behavior of substrate processing apparatus 3 in response to the input target trajectory. The information processing apparatus 1 performs optimization processing using the substrate processing model 5 to generate a target trajectory in which the optimal substrate processing can be achieved.

At this time, the information processing apparatus 1 according to the present embodiment generates an initial value of a target trajectory for a model in a layer one level below (lower layer), based on a target trajectory provided from a layer one level above (upper layer), for a certain layer (target layer) of the substrate processing model 5. The information processing apparatus 1 provides the generated initial value of the target trajectory to a model in the lower layer, and obtains an estimated trajectory based on the model in the lower layer. The information processing apparatus 1 calculates an estimated trajectory of a model in the target layer based on the estimated trajectory of the model in the lower layer, calculates a value of an objective function set for the model in the target layer based on the calculated estimated trajectory, and determines whether the target trajectory provided to the model in the lower layer is optimal based on the calculated value. When it is determined that the target trajectory is not optimal, the information processing apparatus 1 updates the target trajectory to the model in the lower layer as appropriate, provides the target trajectory to the model in the lower layer, and repeats similar processing. When it is determined that the target trajectory is optimal, the information processing apparatus 1 sets the target trajectory of the lower layer at this time as an optimal target trajectory, and provides the estimated trajectory of the model in the target layer at this time to a model in the upper layer.

The information processing apparatus 1 according to the present embodiment recursively performs the optimization processing with respect to the target layer described above, from an uppermost layer to a lowermost layer of the substrate processing model 5 in order. In this way, the information processing apparatus 1 can generate an initial value of the target trajectory in order from the uppermost layer to the lowermost layer, and can generate an optimal target trajectory in order while performing the optimization processing from the lowermost layer to the uppermost layer. The information processing apparatus 1 can cause the substrate processing apparatus 3 to perform desired substrate processing by providing the generated target trajectory of each layer to the substrate processing apparatus 3. The information processing apparatus 1 does not need to provide the generated target trajectories of all the layers to the substrate processing apparatus 3. The information processing apparatus 1 may select the target trajectory for a model corresponding to the physical hardware unit of the substrate processing apparatus 3, for example, and provide the selected target trajectory to the substrate processing apparatus 3.

### <Apparatus Configuration>

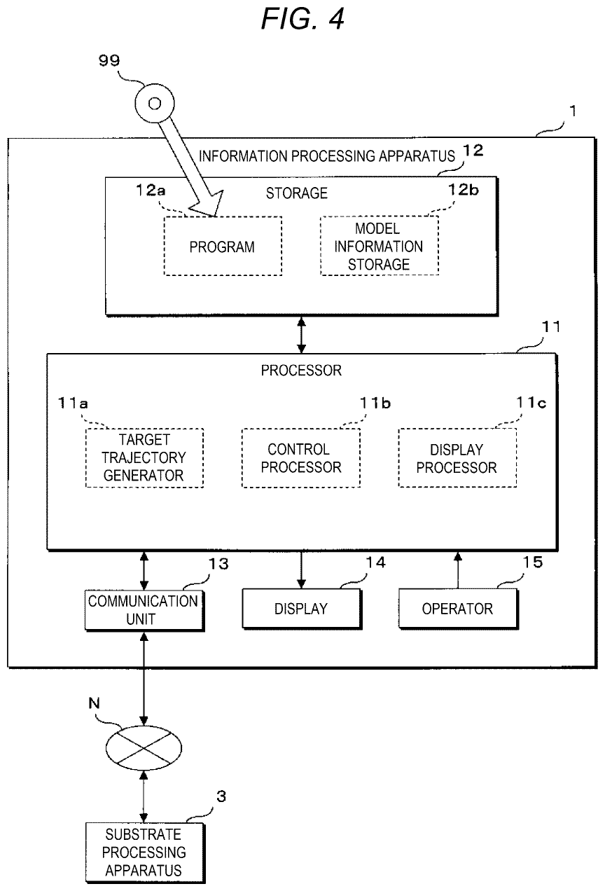

FIG. 4 is a block diagram illustrating a configuration example of the information processing apparatus 1 according to the present embodiment. The information processing apparatus 1 according to the present embodiment can be implemented by installing a given application program or the like in a general-purpose information processing apparatus such as a personal computer or a server computer. The information processing apparatus 1 according to the present embodiment includes a processor 11, a storage 12, a communication unit 13, a display 14, an operator 15, and the like. The information processing apparatus 1 may be a computer such as a quantum annealer, a complementary metal oxide semiconductor (CMOS) annealer, a gate-type quantum computer, or a reservoir computer.

The processor 11 is configured by using an arithmetic processing apparatus such as a central processing unit (CPU), a micro-processing unit (MPU), a graphics processing unit (GPU), or a quantum processor, a read only memory (ROM), a random access memory (RAM), and the like. The processor 11 reads and executes a program 12a stored in the storage 12, thereby performing various types of processing such as processing of generating a target trajectory to be provided to the substrate processing apparatus 3, and processing of acquiring sensor measurement values from the substrate processing apparatus 3.

The storage 12 is configured by using, for example, a large-capacity storage device such as a hard disk or a solid state drive (SSD). The storage 12 stores various types of programs to be executed by the processor 11 and various types of data necessary for the process of the processor 11. In the present embodiment, the storage 12 stores the program 12a to be executed by the processor 11. The storage 12 includes a model information storage 12b that stores information related to a model such as the substrate processing model 5 used for the substrate processing.

In the present embodiment, the program (computer program, program product) 12a is provided in a form recorded on a recording medium 99 such as a memory card or an optical disc. The information processing apparatus 1 reads the program 12a from the recording medium 99, and stores the program 12a in the storage 12. However, for example, the program 12a may be written into the storage 12 during a manufacturing stage of the information processing apparatus 1. For example, as the program 12a, the information processing apparatus 1 may acquire those which are distributed by a remote server device or the like through communication. For example, the program 12a may be written into the storage 12 of the information processing apparatus 1 after a writing apparatus reads data recorded in the recording medium 99. The program 12a may be provided in the form of distribution through a network, or may be provided in the form recorded in the recording medium 99.

The model information storage 12b stores information related to various models, including the substrate processing model 5 generated in advance. The information related to the model may include, for example, information indicating a configuration of the model (mathematical formula or the like), and information such as values of internal parameters determined in advance. In the present embodiment, the model information storage 12b stores, with respect to the plurality of models in the substrate processing model 5, information such as a configuration and parameter of the models, and information indicating how this plurality of models are connected. Each model is generated, for example, by collecting input and output data with respect to the corresponding hardware unit of the substrate processing apparatus 3 in advance, and determining parameters of a model whose configuration is predetermined, such as a physical arithmetic expression or a neural network, to reproduce a correspondence relationship between the input and output based on the collected data. The generation of these models may be performed by the information processing apparatus 1 or by other apparatuses.

The communication unit 13 is connected to the substrate processing apparatus 3 via a wired or wireless network N, and exchanges data with the substrate processing apparatus 3. In the present embodiment, the communication unit 13 transmits data such as the target trajectory provided from the processor 11 to the substrate processing apparatus 3. The communication unit 13 receives data such as sensor measurement values transmitted from the substrate processing apparatus 3 and provides the data to the processor 11.

The display 14 is configured by using a liquid crystal display or the like, and displays various images, characters, and the like based on the process of the processor 11. The display 14 displays various types of information such as a progress of substrate processing performed by the substrate processing apparatus 3, presence or absence of abnormality, the target trajectory transmitted to the substrate processing apparatus 3, or the sensor measurement values acquired from the substrate processing apparatus 3. The operator 15 receives a user operation and notifies the processor 11 of the received operation. For example, the operator 15 receives the user operation by an input device such as a mechanical button or a touch panel provided on a surface of the display 14. For example, the operator 15 may be an input device such as a mouse and a keyboard, and these input devices may be configured to be detachable from the information processing apparatus 1.

The storage 12 may be an external storage device connected to the information processing apparatus 1. The information processing apparatus 1 may be a multi-computer including a plurality of computers, or may be a virtual machine virtually constructed by software. In addition, the information processing apparatus 1 is not limited to the configuration described above, and does not need to include the display 14, the operator 15, and the like, for example.

In the information processing apparatus 1 according to the present embodiment, the processor 11 reads and executes the program 12a stored in the storage 12, thereby implementing a target trajectory generator 11a, a control processor 11b, a display processor 11c, and the like as software functional units in the processor 11. In the drawing, a functional unit performing processing related to control of substrate processing by the substrate processing apparatus 3 is illustrated as a functional unit of the processor 11, and functional units related to other processing are omitted in the drawings.

The target trajectory generator 11a performs processing of generating a target trajectory to be provided to the substrate processing apparatus 3, based on setting information (recipe) related to the substrate processing input by the user and the substrate processing model 5 stored in the model information storage 12b. In the present embodiment, for example, when the substrate processing model 5 has a tree configuration in FIG. 3, the target trajectory generator 11a determines an initial value of a target trajectory of the overall function Ω corresponding to the root node of the substrate processing model 5, based on the input recipe. Next, the target trajectory generator 11a determines initial values of target trajectories of lower-level models connected to the overall function Ω, i.e., the functional unit X and the control system Y, based on the initial value of the target trajectory of the overall function Ω. Similarly, the target trajectory generator 11a determines initial values of target trajectories of lower-level models connected to the functional unit X, i.e., the control systems Z and W, based on the initial value of the target trajectory of the functional unit X.

The control systems Z and W corresponding to the leaf nodes of the substrate processing model 5 perform a simulation of an operation based on the initial values of the provided target trajectories to calculate and output an estimated trajectory with an output value. The target trajectory generator 11a performs a simulation of an operation with respect to the functional unit X, based on the estimated trajectories output from the control systems Z and W and the initial values of the target trajectories provided to the functional unit X. The target trajectory generator 11a calculates a value of an objective function determined for the functional unit X based on a simulation result for the functional unit X, and determines whether the target trajectories provided to the control systems Z and W are optimal based on the calculated value. When the target trajectory is not optimal, the target trajectory generator 11a appropriately updates the target trajectories to the control systems Z and W from the initial values, and determines an optimal target trajectory by repeating similar processing. When the optimal target trajectories for the control systems Z and W are obtained, the target trajectory generator 11a calculates an estimated trajectory for the functional unit X at this time, and based on an estimated trajectory of the control system Y obtained in the same manner as the estimated trajectory of the functional unit X, similarly performs optimization of the target trajectories of the functional unit X and the control system Y using the objective function of the overall function Ω.

In this way, the target trajectory generator 11a can determine initial values of target trajectories in order from the root node to the leaf node in the lower layer with respect to the plurality of models having the tree structure in the substrate processing model 5, and repeat calculation of the estimated trajectory and optimization of the target trajectory in order from the root node to the lower layer, thereby generating an optimal target trajectory to be provided to the substrate processing apparatus 3 through optimization in the final root node.

The target trajectory generated by the target trajectory generator 11a is provided to the substrate processing apparatus 3 as data obtained by time series arrangement of a plurality of target values of substrate processing over a given period. The target trajectory generator 11a repeats the above-described optimization processing for each given period to repeatedly generate a target trajectory. In the present embodiment, when generating the target trajectory for a layer one level below (second layer) based on a target trajectory for a given period provided for a certain layer (first layer) (first given period), the target trajectory generator 11a generates the target trajectory for the second layer for each second given period obtained by dividing the first given period into a plurality of periods. The target trajectory generator 11a acquires estimated trajectories corresponding to the plurality of target trajectories for each second given period, and after an estimated trajectory for the first given period is obtained from the second layer, calculates an estimated trajectory of the first layer. In this way, the target trajectory generator 11a divides periods of the target trajectory in order from the upper layer to the lower layer, and shortens target periods for optimization of the target trajectory in each layer. The target trajectory generator 11a can shorten the target period from the upper layer to the lower layer as described above. However, the target periods having the same length may be adopted throughout the layer.

The control processor 11b transmits the target trajectory generated by the target trajectory generator 11a by the optimization processing to the substrate processing apparatus 3, and controls the substrate processing apparatus 3 to perform substrate processing according to the target trajectory. The optimal target trajectory for each model in each layer of the substrate processing model 5 is obtained by the optimization processing of the target trajectory generator 11a. However, the control processor 11b acquires, for example, a target trajectory in a layer corresponding to the hardware unit of the substrate processing apparatus 3 from the obtained target trajectory in each layer, and transmits the target trajectory corresponding to this hardware unit to the substrate processing apparatus 3.

The control processor 11b acquires information such as the sensor measurement value output as a result of the substrate processing performed by the substrate processing apparatus 3 to which the target trajectory is provided. The control processor 11b may store the acquired sensor measurement value and the like in the storage 12 as log information of the substrate processing, for example, or may provide information to the user by providing the information to the display processor 11c for display, for example. The control processor 11b may provide the sensor measurement value acquired from the substrate processing apparatus 3 to the target trajectory generator 11a, and optimize the next target trajectory based on the sensor measurement value provided from the target trajectory generator 11a.

As described above, the target trajectory generator 11a calculates the target trajectory every given period. When the sensor measurement value obtained from the substrate processing apparatus 3 are used for the generation of the next target trajectory, for example, the control processor 11b provides the target trajectory generated by the target trajectory generator 11a to the substrate processing apparatus 3 at a given cycle for generating the target trajectory of the uppermost layer of the substrate processing model 5, and the control processor 11b repeats the generation of the target trajectory at the next given cycle by the optimization processing by the target trajectory generator 11a based on the sensor measurement value acquired from the substrate processing apparatus 3. When the sensor measurement values acquired from the substrate processing apparatus 3 are not used for the generation of the next target trajectory, for example, the target trajectory generator 11a may generate the target trajectory in advance during the entire period of the substrate processing, and the control processor 11b may provide the target trajectory generated in advance to the substrate processing apparatus 3.

The control processor 11b also calculates a difference (error) between the target trajectory provided to the substrate processing apparatus 3 and an actual trajectory based on the sensor measurement value obtained from the substrate processing apparatus 3, and determines whether the calculated error exceeds a predetermined threshold value. When the error exceeds the threshold value, the control processor 11b may determine that an abnormality or the like has occurred in the substrate processing performed by the substrate processing apparatus 3, and may perform processing such as providing a stop command for the substrate processing to the substrate processing apparatus 3 or outputting a warning message to the user.

The display processor 11c performs processing for displaying various characters, images, and the like on the display 14. In the present embodiment, for example, the display processor 11c graphically displays, on the display 14, the target trajectory provided to the substrate processing apparatus 3 and the actual trajectory based on the sensor measurement value obtained from the substrate processing apparatus 3. For example, the display processor 11c schematically illustrates a layered structure of the substrate processing model 5, and may display operating conditions of the hardware units or the like of the substrate processing apparatus 3 in association with the model in each layer. The display processor 11c may display various types of information other than the above-described information on the display 14.

### Target Trajectory Generation Processing

Hereinafter, a detailed example of the target trajectory generation processing performed by the information processing apparatus 1 will be described. In the present example, the substrate processing apparatus 3 to be controlled by the information processing apparatus 1 will be described as being represented by the configuration of the substrate processing model 5 illustrated in FIG. 3. In the present description, a transmission cycle of the target trajectory from the information processing apparatus 1 to the substrate processing apparatus 3 will be referred to as a “run”, and a period obtained by dividing a time corresponding to one run into a plurality of portions will be referred to as a “step”.

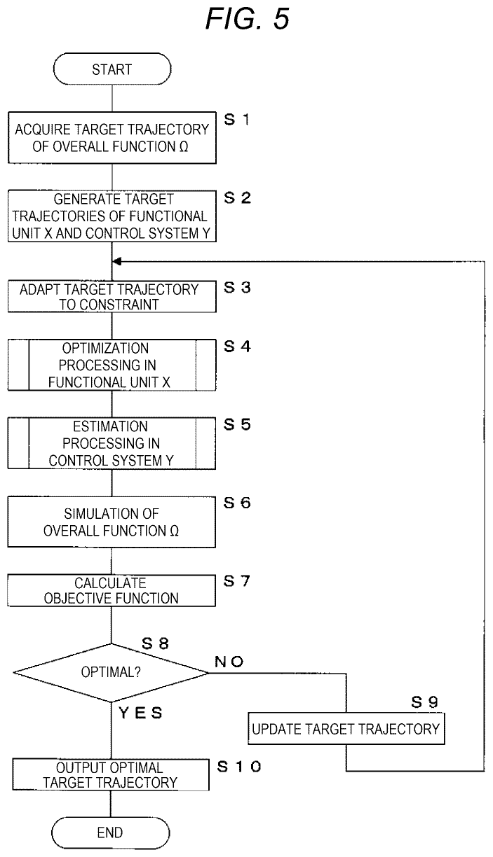

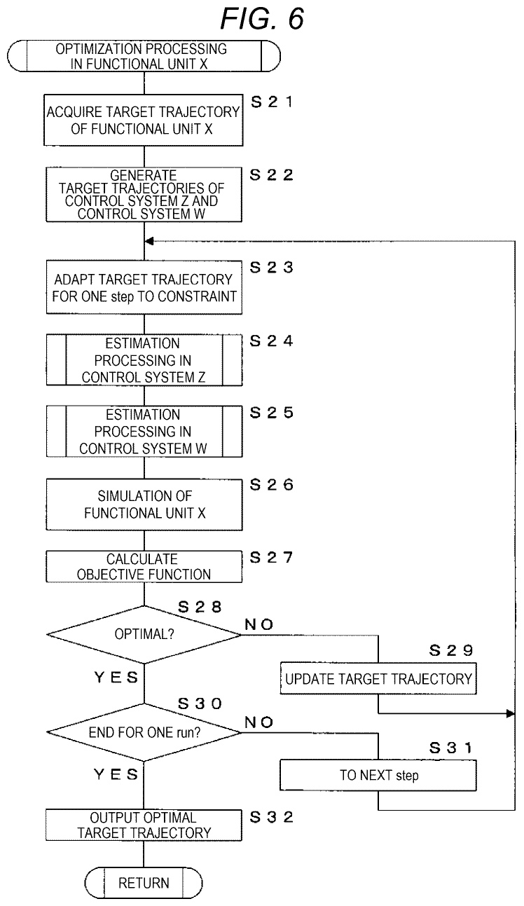

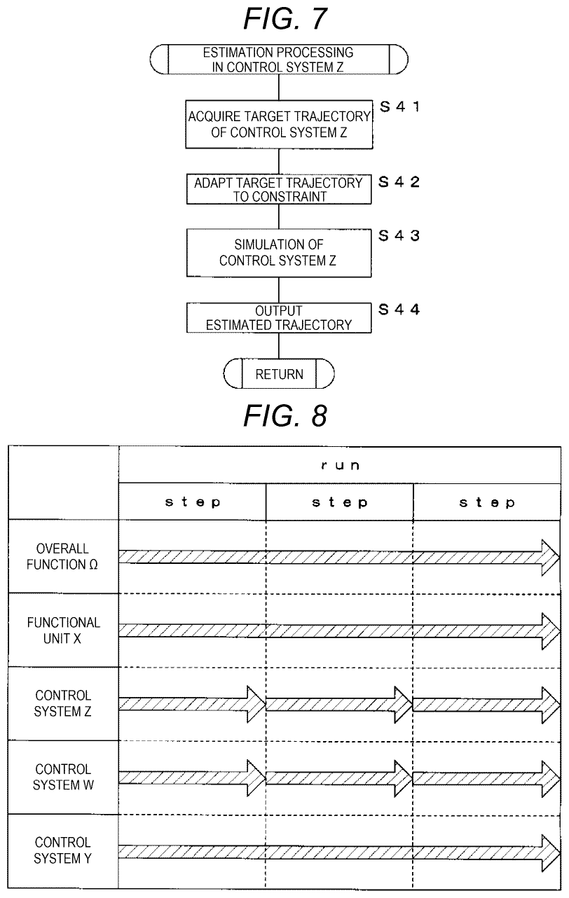

FIG. 5 is a flowchart illustrating an example of a procedure of the optimization processing with respect to the overall function Ω performed by the information processing apparatus 1 in the present embodiment. The procedure of the flowchart in FIG. 5 represents processing for one run, and the information processing apparatus 1 repeats this processing. FIG. 6 is a flowchart illustrating an example of a procedure of optimization processing with respect to the functional unit X performed in the optimization processing with respect to the overall function Ω. FIG. 7 is a flowchart illustrating an example of a procedure of optimization processing with respect to the control system Z performed in the optimization processing with respect to the functional unit X. Since the optimization processing with respect to the control system Y and the control system W is the similar as the optimization processing with respect to the control system Z, a flowchart thereof will be omitted. FIG. 8 is a schematic diagram illustrating a correspondence relationship between each layer of the substrate processing model 5 and the target period of the optimization processing.

As illustrated in FIG. 5, the target trajectory generator 11a of the processor 11 of the information processing apparatus 1 according to the present embodiment acquires a target trajectory related to the optimization processing of the overall function Ω of the substrate processing model 5 (step S1). The target trajectory of the overall function Ω may be set by the user, or may be generated based on, for example, a recipe for the substrate processing generated by the user, or may be determined by any other method. In step S1, the target trajectory generator 11a acquires a target trajectory for one run.

The target trajectory generator 11a generates (initial values of) target trajectories of the functional unit X and the control system Y connected to a lower level of the overall function Ω, based on the target trajectory acquired in step S1 (step S2).

Various methods can be adopted for generating the initial value of the target trajectory in step S2. For example, the target trajectory generator 11a may set a predetermined trajectory as the initial value of the target trajectory. For example, the target trajectory generator 11a may generate a random trajectory and use the generated trajectory as an initial value of the target trajectory. In this case, the target trajectory generator 11a may generate a trajectory under a predetermined condition, such as generating a random trajectory such that values at each time point follow a normal distribution with a mean of 0 and a standard deviation of 2.5.

For example, the target trajectory generator 11a may store an optimal target trajectory obtained through the previous optimization processing, and may set the stored target trajectory as an initial value of a current target trajectory. In this case, it may be inappropriate to use the last optimal target trajectory as the initial value for a current time because, for example, recipe settings for substrate processing differ between a previous time and the current time. Therefore, the target trajectory generator 11a can store, for example, information such as a recipe setting value, a sensor measurement value obtained from the substrate processing apparatus 3 during the substrate processing, or a feature obtained therefrom, and the optimal target trajectory obtained by the optimization processing, in association with each other. The target trajectory generator 11a can search for information similar to the setting value, sensor measurement value, feature, or the like of a current recipe among these pieces of information stored in the past, and use a target trajectory associated with the setting value, sensor measurement value, feature, or the like of the recipe obtained through the search as the initial value of the current target trajectory.

In a configuration in which a setting value, sensor measurement value, feature, and the like of past recipe and a past optimal target trajectory are stored as described above, the information processing apparatus 1 can calculate, for example, errors or similarities between the setting value, sensor measurement value, feature, and the like of the past recipe, and the setting value, sensor measurement value, feature, and the like of the current recipe. When the given condition is satisfied such as when the error is ±0.1% or less, or when the similarity is 99% or more, for example, the information processing apparatus 1 may adopt the stored target trajectory as a current optimal target trajectory, without performing the processing after step S2 of the flowchart, i.e., performing the processing of steps S3 to S9 to be described later, and advance the processing to step S10.

A method of generating the initial value of the target trajectory performed by the target trajectory generator 11a in step S2 is not limited to the method described above. For example, the target trajectory generator 11a may generate a training model in advance, in which a correspondence between a setting value, a sensor measurement value, a feature, or the like of a recipe and a target trajectory is learned through machine learning, and may generate initial value of the target trajectory using the training model. The target trajectory generator 11a may generate the initial value of the target trajectory by appropriately combining the methods described above.

The target trajectory generator 11a adapts the target trajectories of the functional unit X and the control system Y generated in step S2 to a predetermined constraint (step S3). The constraint include, for example, an upper limit value and a lower limit value of the target trajectory, and are predetermined based on, for example, apparatus characteristics of the substrate processing apparatus 3. For example, when a portion exceeding the upper limit value is in a part of the target trajectory, the target trajectory generator 11a can replace this portion with a value less than the upper limit value to adapt to the constraint. The constraints are not limited to the upper limit value and the lower limit value. For example, various types of constraints such as an upper limit of an amount of displacement may be adopted, and various methods for adapting to the constraint other than the replacement of the value may be adopted.

Next, the target trajectory generator 11a performs optimization processing of the target trajectory in the functional unit X based on the target trajectory of the functional unit X that is adapted to the constraint in step S3 (step S4). The target trajectory generator 11a performs estimation processing of the target trajectory in the control system Y based on the target trajectory of the control system Y that is adapted to the constraint in step S3 (step S5). The target trajectory generator 11a performs estimation processing in a layer corresponding to the leaf node in the tree structure of the substrate processing model 5, and performs optimization processing in the other layers. The target trajectory generator 11a may perform either the optimization processing in the functional unit X in step S4 or the estimation processing in the control system Y in step S5 first, or may perform the optimization processing and the estimation processing at the same time. Details of the optimization processing in the functional unit X are illustrated in FIG. 6, and details of the estimation processing in the control system Y are similar as estimation processing in the control system Z illustrated in FIG. 7, and thus are omitted in the drawing.

Processing with respect to the functional unit X in step S4 may be omitted. For example, when it is known that the functional unit X can follow the target trajectory without any problem in a range of a certain target trajectory, it is determined whether the target trajectory of the functional unit X generated in step S2 falls within the range, and when the target trajectory falls within the range, this target trajectory is set as the optimal target trajectory, and the processing in step S4 may be omitted. The target trajectory generator 11a stores in advance a given condition for determining whether such omissions are possible, and when it is determined that the target trajectory generated in step S2 satisfies the given condition, the target trajectory generator 11a omits the processing in step S4 and performs processing of the next step.

The target trajectory generator 11a can obtain the optimal target trajectory of the functional unit X (an estimated trajectory of the functional unit X) with respect to an input target trajectory by the optimization processing in the functional unit X in step S4. Similarly, the target trajectory generator 11a can obtain an estimated trajectory of the control system Y (an optimal target trajectory of the control system Y) with respect to an input target trajectory by the estimation processing in the control system Y in step S5. The target trajectory generator 11a performs a simulation of substrate processing using a model of the overall function Ω, based on the optimal target trajectory of the functional unit X obtained as a result of step S4 and the estimated trajectory of the control system Y obtained as a result of step S5 (step S6). At this time, the target trajectory generator 11a may use the sensor measurement value obtained from the substrate processing apparatus 3 for simulation.

As a result of the simulation in step S6, the target trajectory generator 11a can obtain an estimated trajectory with respect to the target trajectory input to the overall function Ω. Based on the result of the simulation, the target trajectory generator 11a calculates a predetermined objective function for the overall function Ω (step S7). The target trajectory generator 11a determines whether the target trajectories of the functional unit X and the control system Y at that time point are optimal, based on, for example, whether a value of the objective function calculated by the calculation in step S7 exceeds a threshold value (step S8).

When it is determined that the target trajectory is not optimal (S8: NO), the target trajectory generator 11a updates the target trajectories of the functional unit X and the control system Y at that time point so that the value of the objective function becomes smaller (or larger) (step S9), for example, and returns the processing to step S3. The target trajectory generator 11a repeats the processing of steps S3 to S9 until the target trajectory becomes optimal.

The target trajectory generator 11a may update the target trajectory by, for example, a gradient method such as a steepest descent method or a projection gradient method, Bayesian optimization such as Covariance Matrix Adaptation Evolution Strategy (CMA-ES), a genetic algorithm, or a neural network. Hyperparameters required for calculation using these methods may be optimized using methods such as meta-learning using another system different from a present system.

When it is determined that the target trajectory is optimal (S8: YES), the target trajectory generator 11a outputs the target trajectories of the functional unit X and the control system Y at that time point, and the estimated trajectory of the overall function Ω calculated based on the target trajectory, as the optimal target trajectory for one run (step S10), and ends the processing.

The details of the optimization processing performed by the functional unit X in step S4 in the flowchart illustrated in FIG. 5 are illustrated in FIG. 6. In the optimization processing in the functional unit X, the target trajectory generator 11a acquires the target trajectory of the functional unit X provided by the optimization processing in the overall function Ω illustrated in FIG. 5 (step S21). Next, the target trajectory generator 11a generates (initial values of) target trajectories of the control system Z and the control system W connected to a lower level of the functional unit X, based on the target trajectory acquired in step S21 (step S22). The target trajectory generator 11a may generate the initial value of the target trajectory in step S22 in the same manner as described in step S2.

In the present embodiment, the target trajectory provided from the overall function Ω to the functional unit X is one run. However, the target trajectory generator 11a divides a period of one run into a plurality of steps to generate a target trajectory for each step. FIG. 8 illustrates periods of the target trajectories handled by each layer, which are the overall function Ω, the functional unit X, the control system Z, the control system W, and the control system Y. A target trajectory of the period of one run is provided to the overall function Ω. In the present embodiment, the division of the period is not performed in the overall function Ω, and the target trajectory of the period of one run is provided to the functional unit X and the control system Y which are lower layers of the overall function Ω. In the present embodiment, the period of one run is divided into three steps in the functional unit X, and the target trajectory of the period of one step are given to the control system Z and the control system W which are lower layers of the functional unit X. The division of the period illustrated in FIG. 8 is an example and is not limited thereto, and whether to divide the target trajectory and how many parts to divide the target trajectory may be appropriately determined by, for example, the configuration of the substrate processing apparatus 3. In the present embodiment, the target trajectory generator 11a generates target trajectories of the control system Z and the control system W for the three steps based on the target trajectory of the functional unit X for one run in step S22.

The target trajectory generator 11a adapts the target trajectories of the control system Z and the control system W for one step generated in step S22 to the predetermined constraints for the control system Z and the control system W, respectively (step S23). Next, the target trajectory generator 11a performs estimation processing of the target trajectory in the control system Z based on the target trajectory of the control system Z for one step that is adapted to the constraint in step S23 (step S24). The target trajectory generator 11a performs estimation processing of the target trajectory in the control system W based on the target trajectory of the control system W for one step that is adapted to the constraint in step S23 (step S25). The target trajectory generator 11a may perform either the estimation processing in the control system Z in step S24 or the estimation processing in the control system W in step S25 first, or may perform the estimation processing in the control system Z and the estimation processing in the control system W at the same time. Details of the estimation processing in the control system Z are illustrated in FIG. 7, and details of the estimation processing in the control system W are similar as estimation processing in the control system Z illustrated in FIG. 7, and thus are omitted in the drawing.

The target trajectory generator 11a can obtain an estimated trajectory of the control system Z (an optimal target trajectory of the control system Z) with respect to an input target trajectory by the estimation processing in the control system Z in step S24. Similarly, the target trajectory generator 11a can obtain an estimated trajectory (an optimal target trajectory of the control system W) of the control system W with respect to an input target trajectory by the estimation processing in the control system W in step S25. The target trajectory generator 11a performs a simulation of substrate processing using a model of the functional unit X based on the estimated trajectory of the control system Z obtained as a result of step S24 and the estimated trajectory of the control system W obtained as a result of step S25 (step S26).

As a result of the simulation in step S26, the target trajectory generator 11a can obtain an estimated trajectory with respect to the target trajectory input into the functional unit X. Based on the result of the simulation, the target trajectory generator 11a calculates a predetermined objective function for the functional unit X (step S27). The target trajectory generator 11a determines whether the target trajectories of the control system Z and the control system W at that time point are optimal, based on, for example, whether a value of the objective function calculated in step S27 exceeds a threshold value (step S28).

When it is determined that the target trajectory is not optimal (S28: NO), the target trajectory generator 11a updates the target trajectories of the control system Z and the control system W at that time point so that the value of the objective function becomes smaller (or larger) (step S29), for example, and returns the processing to step S23. The target trajectory generator 11a repeats the processing of steps S23 to S29 until the target trajectory becomes optimal.

When it is determined that the target trajectory is optimal (YES in step S28), the target trajectory generator 11a determines whether the optimization processing for one run ends (step S30). When the optimization processing for one run does not end (NO in step S30), the target trajectory generator 11a shifts a processing target to the next step (step S31), and returns the processing to step S23. The target trajectory generator 11a repeats the processing of steps S23 to S31 until the optimization processing for one run, i.e., the optimization processing for three steps, ends.

When the optimization processing for one run ends (S30: YES), the target trajectory generator 11a outputs the target trajectories of the control system Z and the control system W for one run at that time point and the estimated trajectories of the functional units X calculated based on the target trajectories, as the optimal target trajectory for one run (step S32), and ends the optimization processing in the functional unit X, and returns the processing to the optimization processing for the overall function Ω.

The details of the estimation processing performed by the control system Z in step S24 in the flowchart illustrated in FIG. 6 are illustrated in FIG. 7. In the estimation processing in the control system Z, the target trajectory generator 11a acquires a target trajectory of the control system Z provided by the optimization processing in the functional unit X illustrated in FIG. 6 (step S41). Next, the target trajectory generator 11a adapts the target trajectory of the control system Z acquired in step S41 to a predetermined constraint for the control system Z (step S42).

Next, the target trajectory generator 11a performs a simulation of substrate processing using a model of the control system Z, based on the target trajectory of the control system Z that is adapted to the constraint in step S42 (step S43). As a result of the simulation in step S43, the target trajectory generator 11a can obtain an estimated trajectory with respect to the target trajectory input to the control system Z. The target trajectory generator 11a outputs the estimated trajectory of the control system Z obtained as the result of the simulation (step S44), ends the estimation processing in the control system Z, and returns the processing to the optimization processing in the functional unit X.

In this way, the information processing apparatus 1 according to the present embodiment can generate an optimal target trajectory at each layer in the substrate processing model 5 by recursively repeating the optimization processing from the overall function Ω that is the uppermost layer of the substrate processing model 5 to the lower layer in order. In the present embodiment, the substrate processing model 5 has a tree-type layered structure as illustrated in FIG. 3. When the target trajectory is generated by the optimization processing using the substrate processing model 5 having such a layered structure, the processing illustrated in the flowchart in FIG. 5 is performed in a layer corresponding to the root node of the tree structure, the processing illustrated in the flowchart in FIG. 7 is performed in a layer corresponding to the leaf node, and the processing illustrated in the flowchart in FIG. 6 is performed in a middle layer other than that.

The control processor 11b of the information processing apparatus 1 according to the present embodiment causes the substrate processing apparatus 3 to perform desired substrate processing by providing a target trajectory generated by the target trajectory generator 11a by the optimization processing using the substrate processing model 5 to the substrate processing apparatus 3. As described above, the target trajectory generator 11a may generate target trajectories corresponding to a model of each layer in the substrate processing model 5, and the control processor 11b may provide all of the target trajectories of these layers to the substrate processing apparatus 3, or may appropriately select a necessary target trajectory and provide the selected target trajectory to the substrate processing apparatus 3.

For example, the information processing apparatus 1 may provide the target trajectory of the functional unit X to the substrate processing apparatus 3, and in this case, the substrate processing apparatus 3 generates the target trajectories of the control system Z and the control system W based on the provided target trajectory of the functional unit X, and inputs the generated target trajectories to the control system Z and the control system W, respectively, so as to operate the control system Z and the control system W, respectively. For example, the information processing apparatus 1 may provide the target trajectories of the control system Z and the control system W to the substrate processing apparatus 3, and in this case, the substrate processing apparatus 3 inputs the target trajectories provided from the information processing apparatus 1 to the control system Z and the control system W, respectively, so as to operate the control system Z and the control system W, respectively. In the present embodiment, the target trajectory for each period of one run is provided from the information processing apparatus 1 to the substrate processing apparatus 3. However, the present disclosure is not limited thereto, and for example, the target trajectory for each period of one step may be provided.

In the present embodiment, the information processing apparatus 1 generates the optimal target trajectory by repeating update by the optimization processing based on the initial value of the target trajectory. However, the present disclosure is not limited thereto. The information processing apparatus 1 may generate an optimal target trajectory using, for example, an inverse model of one or more models in the substrate processing model 5. The inverse model is a model that receives, as an input, for example, a value of an objective function, a target trajectory of another functional unit concerned, or data representing an operating state, and outputs a target trajectory that achieves the value of the objective function. The inverse model is generated in advance based on, for example, information obtained from the substrate processing apparatus 3, and stored in the storage 12 of the information processing apparatus 1. The information processing apparatus 1 may perform the optimization processing with the target trajectory output by the inverse model as the initial value for the repetitive calculation described above.

The information processing apparatus 1 may consider a constraint condition or the like appropriately input by the user or another system when calculating an objective function in each layer or performing a simulation using a model. For example, the information processing apparatus 1 may stop the repetitive calculation at a stage when it is found that the input constraint condition is not satisfied, and perform the optimization processing again by updating the target trajectory.

The information processing apparatus 1 may update the target trajectory by using, for example, a function that includes adjustable parameters such as a neural network that receives, as an input, a previous target trajectory, a value of an objective function obtained from the target trajectory, and data indicating a target trajectory or an operating state of another related functional unit, and outputs a new target trajectory. The information processing apparatus 1 may be configured in advance to learn and configure adjustable parameter of this function so as to optimize a speed at which the value of the objective function decreases by the optimization processing. Similarly, the objective function other than an overall objective function, a constraint adaptation function, a simulation model, or the like may include adjustable parameters, and these adjustable parameters may be learned and configured in advance so as to optimize the speed at which the objective function decreases by the optimization.

The information processing apparatus 1 may calculate time series data of a control operation amount, power consumption, or the like in the processing in the control system illustrated in the flowchart in FIG. 7, for example, and perform a simulation or optimization calculation using a calculation result. For example, calculation may be performed such as adding a monotonically increasing function acting on power consumed by each control system to an overall objective function of optimization.

For example, with respect to the control systems Y, Z, and W corresponding to the leaf nodes, when the models of these control systems use only values designated by the target trajectory, and when a difference between the target trajectory and the estimated trajectory of a control result can be ignored as a result of adaptation to the constraint condition, the information processing apparatus 1 can omit the processing such as the simulation in the optimization processing illustrated in the flowcharts in FIGS. 5 to 7. In other words, the information processing apparatus 1 may omit the processing related to the control system Z illustrated in FIG. 7, for example, assuming that (initial value of) the target trajectory and the estimated trajectory coincide with each other with respect to the control system Z.

For repetition processing performed in the optimization processing of each layer, the information processing apparatus 1 can adopt conditions such as a case where the value of the objective function is equal to or less than a threshold value, a case where the value of the objective function is equal to or less than a threshold value depending on the number of times of repetitions, or a case where the number of times of repetitions exceeds the threshold value, as a repetition end condition. When performing a plurality of cases of optimization processing in parallel, for example, the information processing apparatus 1 may end repetition of another optimization processing in accordance with an end of repetition of one optimization processing, or may extend the repetition of another optimization processing until the repetition of one optimization processing ends.

The information processing apparatus 1 may calculate a predicted error with respect to the target trajectory calculated as optimal in the optimization processing of each layer. For example, the information processing apparatus 1 can set the error to be ±1 standard deviation of a calculation result. The information processing apparatus 1 can propagate the error calculated from the lower layer to the upper layer, and perform processing according to the error, such as performing the optimization processing again when a final error exceeds an allowable value.

The information processing apparatus 1 may transmit information such as a result of the optimization processing or a result of a simulation using the substrate processing model 5 to a server apparatus or the like and accumulate the information, and the server apparatus may perform processing such as updating the substrate processing model 5 using the accumulated information. The server apparatus may acquire information about the plurality of substrate processing apparatuses 3 from the corresponding information processing apparatuses 1 and accumulate the information, generate an average substrate processing model 5 for the plurality of substrate processing apparatuses 3 using the accumulated information, and transmit the generated average substrate processing model 5 to each information processing apparatus 1. The information processing apparatus 1 may acquire the average substrate processing model 5 from the server apparatus, and generate a substrate processing model 5 suitable for the substrate processing apparatus 3 to be controlled by the information processing apparatus 1 itself, based on the acquired average substrate processing model 5.

The information processing apparatus 1 may limit search for an optimal target trajectory in optimization processing of each layer to a vicinity of an initial value of a provided target trajectory. In this case, for example, the server apparatus or the like may optimize the initial value of the target trajectory with respect to standard setting of the substrate processing, and distribute the initial value of the optimal target trajectory to the information processing apparatus 1. When the setting in each substrate processing apparatus 3 deviates from the standard setting, the information processing apparatus 1 may generate an optimal target trajectory by solving a reduced-order optimization problem by using the perturbation theory regarding the deviation. For example, when a target trajectory of a heater output when a temperature of the apparatus is 25° C. is X1, the information processing apparatus 1 may set a target trajectory X=X1 +δX of the heater output when the temperature of the apparatus is 27° C., linearize the optimization problem while ignoring a second or higher order term related to δX and a temperature difference δT=2° C., and calculate δX.

### <Summary>

In the information processing system according to the present embodiment configured as described above, the information processing apparatus 1 includes the substrate processing model 5 related to substrate processing performed by the substrate processing apparatus 3, and performs processing of generating a target trajectory for the substrate processing performed by the substrate processing apparatus 3 using the substrate processing model 5. The substrate processing model 5 has a layered structure in which one or more models in the lower layer are connected to a model in the upper layer. Each model in substrate processing model 5 receives the target trajectory as an input, and outputs an estimated trajectory estimated for this target trajectory.

For example, when the model in the upper layer is defined as the functional unit X, and the model in the lower layer is defined as the control system Z and the control system W, the information processing apparatus 1 acquires the target trajectory of the functional unit X, generates (initial values of) the target trajectories of the control system Z and the control system W based on the acquired target trajectory, and provides the generated target trajectories to the control system Z and the control system W, respectively. The information processing apparatus 1 acquires the estimated trajectories (lower-level estimated trajectories) output by the control system Z and the control system W, performs a simulation using a model of the functional unit X based on the acquired estimated trajectories to calculate the estimated trajectory (upper-level estimated trajectory) of the functional unit X, calculates a value of the objective function of the functional unit X based on the calculated estimated trajectory, and determines whether the calculated value satisfies a given condition. When the calculated value does not satisfy the given condition, the information processing apparatus 1 updates the target trajectories of the control system Z and the control system W to recalculate the estimated trajectory of the functional unit X. When the calculated value satisfies the given condition, the information processing apparatus 1 outputs the target trajectory at that time point as the optimal target trajectory. Accordingly, the information processing system according to the present embodiment can control an operation of the substrate processing apparatus 3 using the generated target trajectory, and can be expected to achieve control of the substrate processing using the substrate processing model 5.

In the information processing system according to the present embodiment, the information processing apparatus 1 acquires a target trajectory for a first given time (one run) of the upper-level model (functional unit X), generates a target trajectory of the lower-level model (control system Z and control system W) in a second given time (one step) obtained by dividing one run into a plurality of parts, and performs the processing for each one step multiple times in a plurality of divisions. Accordingly, the information processing system according to the present embodiment can make granularity of the optimization processing different for the models of a plurality of layers in the substrate processing model 5, and can be expected to improve computational efficiency of the optimization processing compared with a case where the optimization processing of all the layers are performed in the same time unit.

In the information processing system according to the present embodiment, the substrate processing model 5 has a tree structure in which a plurality of lower-level models are connected to the upper-level model. The model corresponding to the leaf node of the tree structure is a model that reproduces the behavior of the hardware unit of the substrate processing apparatus 3. The information processing apparatus 1 controls the substrate processing performed by the substrate processing apparatus 3 by providing, to the substrate processing apparatus 3, a target trajectory generated for a model corresponding to the root node, a target trajectory generated for a model corresponding to the leaf node, and/or a target trajectory generated for a model corresponding to a node other than the root node and the leaf node. As a result, the information processing system according to the present embodiment can be expected to achieve control of the substrate processing using the substrate processing model 5 having the tree structure.

The substrate processing model 5 is not limited to the tree structure. The substrate processing model 5 may include, for example, a structure in which one lower-level model is connected to two upper-level models. For example, when a temperature control function of the substrate processing apparatus 3 includes a heater and a cooler, a model of the temperature control function may be configured such that a heater target trajectory is provided from a first upper-level model and a cooler target trajectory is provided from a second upper-level model. In this case, for example, the first upper-level model may be configured to provide the cooler target trajectory from the second upper-level model and generate the heater target trajectory based on the cooler target trajectory.

In the information processing system according to the present embodiment, the information processing apparatus 1 adapts the acquired target trajectory of the upper layer to the predetermined constraint condition for the model of the upper layer, and generates a target trajectory to the model of the lower layer based on the target trajectory adapted to the constraint condition. Accordingly, the information processing system according to the present embodiment can be expected to generate a target trajectory in consideration of, for example, a hardware constraint of the substrate processing apparatus 3.

The embodiments disclosed herein are exemplary in all respects and can be considered to be not restrictive. The scope of the present disclosure is indicated by the claims, not the above-described meaning, and is intended to include all modifications within the meaning and scope equivalent to the claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the disclosure is not limited thereto. The claims may also be described using a format of multi-claims reciting at least one multi-claim (multi-multi claims). The disclosed information processing method, computer program, and apparatus integrate the substrate processing model into a practical application for controlling physical substrate processing in semiconductor manufacturing. By generating and optimizing target trajectories using hierarchical models and transmitting them to the substrate processing apparatus, the invention enables precise, real-time control of processes such as chemical vapor deposition (CVD), sputtering, or etching on physical substrates (e.g., semiconductor wafers). This results in technical improvements including enhanced wafer uniformity, reduced manufacturing defects, and increased yield compared to conventional systems that rely on static recipes without dynamic simulation-based optimization. Sensor measurements from the substrate processing apparatus are used to update the models, allowing adaptive control that responds to real-world variations in hardware behavior.

1. An information processing method in which an information processing apparatus uses a substrate processing model related to substrate processing performed by a substrate processing apparatus to generate a target trajectory for the substrate processing of the substrate processing apparatus,
the substrate processing model including an upper-level model and a lower-level model connected to the upper-level model,
the upper-level model and the lower-level model being models that receive the target trajectory as an output target and output an estimated trajectory estimated for the target trajectory,
the information processing method comprising:
by the information processing apparatus,
acquiring an upper-level target trajectory as the output target of the upper-level model,
generating a lower-level target trajectory as the output target of the lower-level model based on the acquired upper-level target trajectory,
providing the generated lower-level target trajectory to the lower-level model to acquire a lower-level estimated trajectory output by the lower-level model,
performing a simulation based on the acquired lower-level estimated trajectory to calculate an upper-level estimated trajectory related to an output value of the upper-level model,
when the calculated upper-level estimated trajectory does not satisfy a given condition, updating the lower-level target trajectory of the lower-level model to recalculate the upper-level estimated trajectory, and
when the calculated upper-level estimated trajectory satisfies the given condition, outputting the lower-level target trajectory as a target trajectory of the lower-level model, and
performing substrate processing utilizing the target trajectory of the lower-level model.

2. The information processing method according to claim 1, further comprising:
by the information processing apparatus,
acquiring the upper-level target trajectory in a first given time,
generating a plurality of the lower-level target trajectories in a second given time obtained by dividing the first given time, and
performing calculation of the upper-level estimated trajectory in a plurality of divisions.

3. The information processing method according to claim 1, further comprising:
by the information processing apparatus,
calculating a value of an objective function determined for the upper-level model based on the calculated upper-level estimated trajectory, and
determining whether the calculated value satisfies the given condition.

4. The information processing method according to claim 1, wherein
the substrate processing model has a tree structure in which a plurality of lower-level models are connected to the upper-level model.

5. The information processing method according to claim 4, wherein
a model corresponding to a leaf node of the tree structure of the substrate processing model reproduces a behavior of circuitry of the substrate processing apparatus.

6. The information processing method according to claim 4, further comprising:
by the information processing apparatus,
controlling the substrate processing based on a target trajectory generated for a model corresponding to a root node of the tree structure of the substrate processing model, a target trajectory generated for a model corresponding to a leaf node, or a target trajectory generated for a model corresponding to a node other than the root node and the leaf node.

7. The information processing method according to claim 1, further comprising:
by the information processing apparatus,
correcting the acquired upper-level target trajectory to a trajectory that adapts to a predetermined constraint condition for the upper-level model, and
generating the lower-level target trajectory by using the corrected trajectory as the upper-level target trajectory.

8. The information processing method according to claim 1, further comprising:
by the information processing apparatus,
determining whether the generated lower-level target trajectory satisfies a given condition, and
when the given condition is satisfied, setting the generated lower-level target trajectory as the lower-level estimated trajectory.

9. The information processing method according to claim 1, further comprising:
by the information processing apparatus,
storing the output target trajectory of the lower-level model, and
setting the stored target trajectory of the lower-level model as the lower-level target trajectory when generating the lower-level target trajectory.

10. The information processing method according to claim 1, wherein
the substrate processing model includes a plurality of models connected in a layered structure of three or more layers, and
the information processing method further comprises:
by the information processing apparatus,
performing processing of generating the target trajectory for a set of two models having a connection relationship of the upper-level model and the lower-level model in the substrate processing model.

11. A non-transitory computer-readable storage medium having a computer program for causing a computer to execute processing of using a substrate processing model related to substrate processing performed by a substrate processing apparatus to generate a target trajectory for the substrate processing of the substrate processing apparatus,
the substrate processing model including an upper-level model and a lower-level model connected to the upper-level model,
the upper-level model and the lower-level model being models that receive the target trajectory as an output target and output an estimated trajectory estimated for the target trajectory, and
the computer program causing the computer to execute processing of:
acquiring an upper-level target trajectory as the output target of the upper-level model,
generating a lower-level target trajectory as the output target of the lower-level model based on the acquired upper-level target trajectory,
providing the generated lower-level target trajectory to the lower-level model to acquire a lower-level estimated trajectory output by the lower-level model,
performing a simulation based on the acquired lower-level estimated trajectory to calculate an upper-level estimated trajectory related to an output value of the upper-level model,
when the calculated upper-level estimated trajectory does not satisfy a given condition, updating the lower-level target trajectory of the lower-level model to recalculate the upper-level estimated trajectory,
when the calculated upper-level estimated trajectory satisfies the given condition, outputting the lower-level target trajectory as a target trajectory of the lower-level model, and
performing substrate processing utilizing the target trajectory of the lower-level model.

12. The non-transitory computer-readable storage medium according to claim 11, wherein the computer program further causes the computer to execute processing of:
acquiring the upper-level target trajectory in a first given time,
generating a plurality of the lower-level target trajectories in a second given time obtained by dividing the first given time, and
performing calculation of the upper-level estimated trajectory in a plurality of divisions.

13. The non-transitory computer-readable storage medium according to claim 11, wherein the computer program further causes the computer to execute processing of:
calculating a value of an objective function determined for the upper-level model based on the calculated upper-level estimated trajectory, and
determining whether the calculated value satisfies the given condition.

14. The non-transitory computer-readable storage medium according to claim 11, wherein
the substrate processing model has a tree structure in which a plurality of lower-level models are connected to the upper-level model.

15. The non-transitory computer-readable storage medium according to claim 14, wherein
a model corresponding to a leaf node of the tree structure of the substrate processing model reproduces a behavior of circuitry of the substrate processing apparatus.

16. An information processing apparatus comprising:
a substrate processing model related to substrate processing performed by a substrate processing apparatus, and
circuitry configured to generate a target trajectory for the substrate processing performed by the substrate processing apparatus using the substrate processing model, wherein the substrate processing model includes an upper-level model and a lower-level model connected to the upper-level model,
the upper-level model and the lower-level model are models that receive the target trajectory as an output target and output an estimated trajectory estimated for the target trajectory, and
the circuitry
acquires an upper-level target trajectory as the output target of the upper-level model,
generates a lower-level target trajectory as the output target of the lower-level model based on the acquired upper-level target trajectory,
provides the generated lower-level target trajectory to the lower-level model to acquire a lower-level estimated trajectory output by the lower-level model,
performs a simulation based on the acquired lower-level estimated trajectory to calculate an upper-level estimated trajectory related to an output value of the upper-level model,
when the calculated upper-level estimated trajectory does not satisfy a given condition, updates the lower-level target trajectory of the lower-level model to recalculate the upper-level estimated trajectory,
when the calculated upper-level estimated trajectory satisfies the given condition, outputs the lower-level target trajectory as a target trajectory of the lower-level model, and
performs substrate processing utilizing the target trajectory of the lower-level model.

17. The information processing apparatus according to claim 16, wherein the circuitry is further configured to:
acquire the upper-level target trajectory in a first given time,
generate a plurality of the lower-level target trajectories in a second given time obtained by dividing the first given time, and
perform calculation of the upper-level estimated trajectory in a plurality of divisions.

18. The information processing apparatus according to claim 16, wherein the circuitry is further configured to:
calculate a value of an objective function determined for the upper-level model based on the calculated upper-level estimated trajectory, and
determine whether the calculated value satisfies the given condition.

19. The information processing apparatus according to claim 16, wherein
the substrate processing model has a tree structure in which a plurality of lower-level models are connected to the upper-level model.

20. The information processing apparatus according to claim 19, wherein
a model corresponding to a leaf node of the tree structure of the substrate processing model reproduces a behavior of circuitry of the substrate processing apparatus.
